(19) United States
(12) Patent Application Publication
(10) Pub. No.: US 2009/0083486 A1
(43) Pub. Date: Mar. 26, 2009

(54) TESTING DEVICE OF CARD READING INTERFACE AND TESTING METHOD THEREOF

(75) Inventors: Town CHEN, Tianjin (CN); Qi ZHAO, Tiajin (CN); Gang ZHOU, Tiajin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPRATION, Taipei (TW)

(21) Appl. No.: 11/858,201

(22) Filed: Sep. 20, 2007

(51) Int. Cl. G06F 12/00

(52) U.S. Cl. 711/115; 711/E12.001

(57) ABSTRACT

A testing device and method of card reading interface are applied to a card reading interface including a plurality of memory cards, and are used to integrate memory card interfaces in a memory card slot. The testing device includes memory cards, a switching unit, a connecting part, and a connecting circuit. Wherein, the switching unit receives a switching instruction and selects a corresponding memory card according to the switching instruction. The connecting part is electrically connected between the memory card slot and the switching unit. The connecting circuit is connected between the switching unit and the memory cards, and transmits detection data to the laptop computer. The laptop computer checks the detection data before testing and after testing. Thus, the device and method thereof can detects function normally or not on the memory card slot, and reduces the plugging times from the memory card slot.

### BACKGROUND OF THE INVENTION

1. Field of Invention

The present invention relates to a testing device of a card reading interface and a testing method thereof, and more particularly to a testing device for testing a card reading interface having a plurality of memory card interfaces.

2. Related Art

As more and more types of memory cards are available now, users have to buy card reading interfaces corresponding to the memory cards, so as to access data in the memory cards. For example, if a user uses a CF memory card, he/she must buy an additional CF card reading interface. If a user wants to access data in an SD memory card, he/she must buy an additional SD card reading interface. Therefore, a memory card of one specification requires a corresponding card reading interface, which causes a lot of inconvenience to the user. In order to solve the problem that many card reading interfaces are required, manufacturers have integrated a plurality of specifications of card reading interfaces into one body. An all-in-one card reading interface 110 arranges various memory card interfaces in a same memory card interface 111 sequentially according to shapes of the memory cards.

FIG. 1 is a schematic view of the connection between a memory card slot having a plurality of memory card interfaces and memory cards. The user can use a memory card as long as the corresponding position of the memory card in the memory card slot 111 is found. For example, as shown in FIG. 1, the CF memory card slot is arranged in the upper part of the memory card slot 111, and the SD memory card slot and the MS memory card slot are arranged in the lower part of the memory card slot 111. Thus, pins corresponding to different memory card interfaces can be arranged in the memory card slot 111. In this way, many different memory cards can be integrated in a card reading interface 110, and the volume of the card reading interface 110 is reduced as well. In order to expand the connectivity of laptop computers, the all-in-one card reading interface 110 has been arranged in many laptop computers. Thus, the user does not have to carry an additional card reading interface 110 when traveling.

In order to test the all-in-one card reading interface 11 0, a normal testing method of the manufacturers is as follows. Referring to FIG. 2, a memory card is selected (S210). The selected memory card is inserted into the corresponding memory card slot (S220). The laptop computer provides a testing signal to the memory card (S230). The laptop computer detects the testing signal before it is sent and the received testing signal (S240). After comparison, if the result is correct, repeat Step 210 until all of the memory cards are detected. According to this testing method, the memory cards must be inserted in and drawn out. Taking an N-in-one card reading interface 110 as an example, the inserting and drawing and the testing must be performed for N times. The inserting and drawing will cause more or less damages to the card reading interface 110 and the memory cards under test.

In particular, as many laptop computers must be tested, the memory cards must be inserted in or drawn out for more times, so they are easier to be abraded. Therefore, the manufacturers must purchase new memory cards frequently, which will increase the cost of the testing.

### SUMMARY OF THE INVENTION

Accordingly, the present invention is directed to providing a testing device of a card reading interface, which is connected to a card reading interface of a laptop computer. A memory card slot is arranged in the card reading interface, and a plurality of specifications of memory card interfaces is arranged in the memory card slot.

In order to achieve the aforementioned objective, the present invention provides a testing device of a card reading interface. A laptop computer provides a memory card interface having at least one memory card interface. The testing device is electrically connected to the memory card slot. The testing device includes memory cards, a switching unit, a connecting part, and a connecting circuit.

The testing device provides the memory cards of a plurality of interface specifications. The switching unit is electrically connected to the laptop computer, and receives a switching instruction sent from the laptop computer. The switching unit selects the corresponding memory card according to the received switching instruction. The connecting part is electrically connected between the memory card slot and the switching unit. The connecting circuit is electrically connected between the switching unit and the memory cards, and transmits detection data, such that the laptop computer detects the detection data before and after the detection data are accessed, so as to determine whether the memory card slot functions normally.

In another aspect, the present invention provides a testing method of a card reading interface, which is connected to a card reading interface in a laptop computer. A memory card slot is arranged in the card reading interface, and a plurality of specifications of memory card interfaces is arranged in the memory card slot. The testing method includes the following steps.

A plurality of memory cards is integrated in a testing device. The testing device is electrically connected with memory card interfaces of the memory card slot. A memory card under test is selected from the plurality of memory cards, and communication is established between the selected memory card and the corresponding memory card interface in the memory card slot through the testing device. A detection data is sent to the selected memory card, and the sent detection data is read from the selected memory card. The sent detection data and the read data are compared, so as to determine whether an error occurs in the corresponding memory card interface in the memory card slot.

The present invention provides a testing device of a card reading interface, which is connected to a card reading interface having a plurality of specifications of memory card interfaces, so as to reduce the times that memory cards are inserted in or drawn out from the card reading interface slot. The laptop computer sends the switching instruction, so as to select the memory card interface under test.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the connection between a memory card slot having a plurality of memory card interfaces and memory cards;

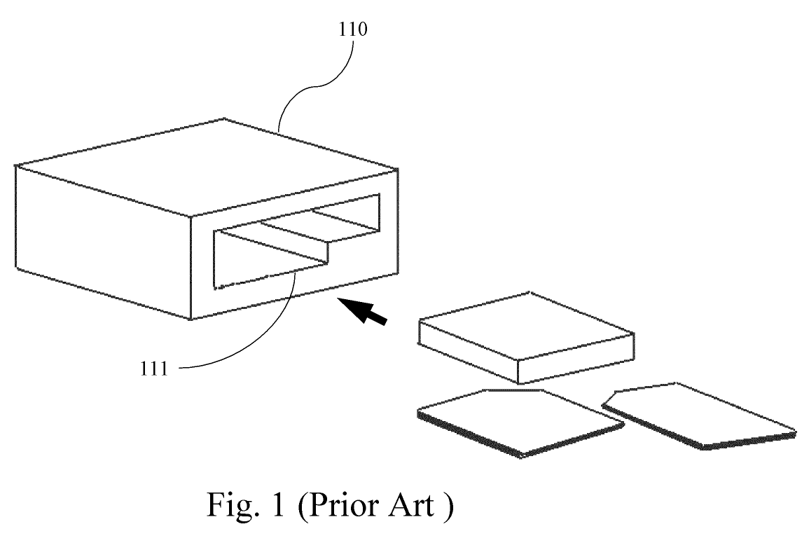

FIG. 2 is a flow chart of testing according to the prior art;

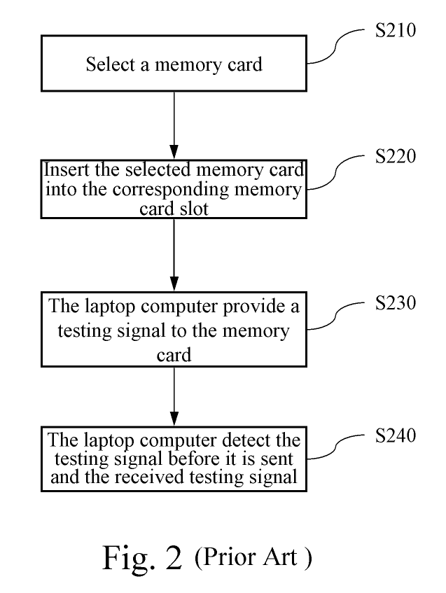

FIG. 3 is a schematic view showing the connection between a laptop computer and the present invention;

FIG. 4 is a flow chart of the testing according to the present invention; and

FIG. 5 is a schematic view showing the connection of the memory cards in the present invention.

### DETAILED DESCRIPTION OF THE INVENTION

The present invention provides a testing device 300 of a card reading interface 110. A laptop computer provides a memory card slot, which can be, but is not limited to, memory cards of Compact Flash (CF) interface, Secure Digital (SD) interface, Memory Stick (MS) interface, Smart Media (SM) interface, XD interface or Multimedia Card (MMC) interface, or Memory Stick Pro (MSP) interface. The testing device 300 includes a connecting part 310, memory cards 320, a switching unit 330, and a connecting circuit 340.

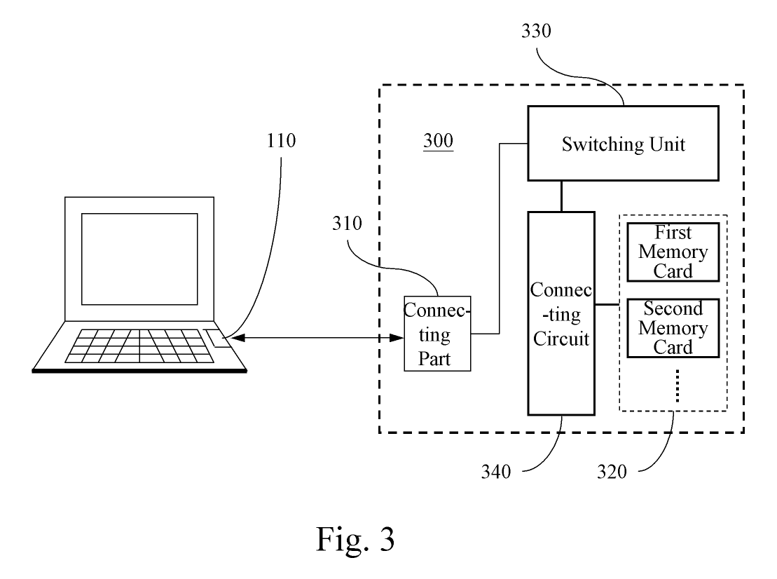

FIG. 3 is a schematic view showing the connection between the laptop computer and the present invention. A plurality of specifications of memory cards 320 is arranged in the testing device 300, and is integrated on a circuit board. The connecting part 310 is electrically connected between the memory card slot 111 and the switching unit 330. In order to reduce the times that the memory cards are inserted in or drawn out from the memory card slot 111, the appearance of the connecting part 310 is designed to be in conformity with the memory card slot 111, and corresponding to the memory card interfaces in the memory card slot 111. Therefore, the testing device 300 includes a plurality of memory cards 320 of various interface specifications at the same time, such as CF memory card, SD memory card, MS memory card, SM memory card, XD memory card or MMC memory card, and Memory Stick Pro (MS Pro) memory card. When the connecting part 310 is placed into the memory card slot 111, the testing device 300 is electrically connected to all the memory card interfaces in the memory card slot 111.

The switching unit 330 is electrically connected to the laptop computer, and receives a switching instruction sent from the laptop computer. The switching unit 330 selects a corresponding memory card 320 according to the received switching instruction. The switching instruction is a Serial Peripheral Interface (SPI) command. The SPI is a synchronous serial data protocol between a microprocessor and peripheral devices for providing high bandwidth network connection between the CPU and peripheral elements.

The connecting circuit 340 is electrically connected between the switching unit 330 and the memory cards 320, and transmits detection data to the memory cards 320, such that the laptop computer detects the detection data before and after the detection data are accessed, so as to determine whether the memory card slot 111 functions are normally. The laptop computer sends the SPI command, so as to trigger a chip selecting pin in the memory card 320.

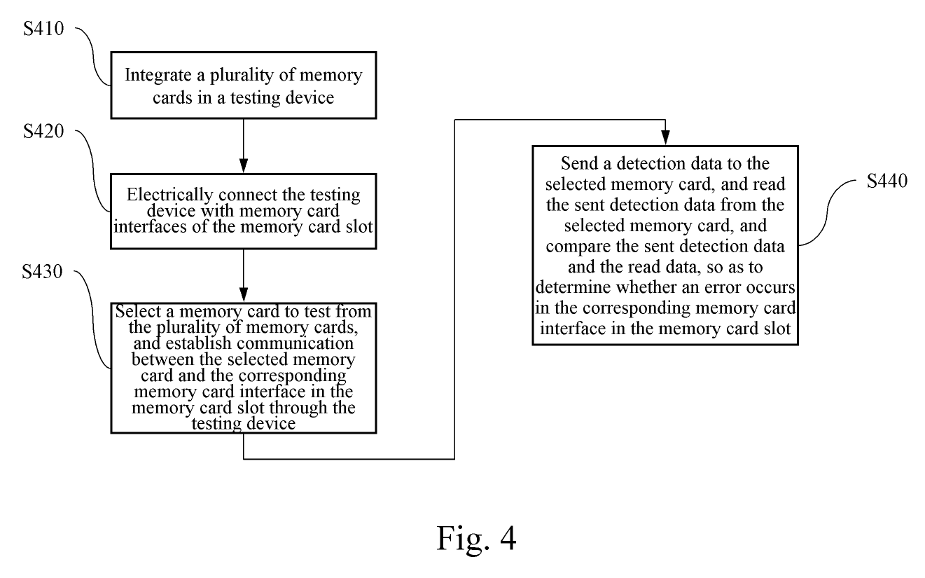

As for the operating flow of the testing device of the present invention, the testing method has the following steps. Referring to FIG. 4, a plurality of memory cards is integrated in a testing device (step S410). The testing device is electrically connected with memory card interfaces of the memory card slot (step S420). A memory card under test is selected from the plurality of memory cards, and communication is established between the selected memory card and the corresponding memory card interface in the memory card slot through the testing device (S430). A detection data is sent to the selected memory card, and the sent detection data is read from the selected memory card. The sent detection data and the read data are compared, so as to determine whether an error occurs in the corresponding memory card interface in the memory card slot (step S440). Then, repeat step S430 to select other memory cards, until all of the memory card interfaces are tested.

In order to describe the operating flow of the present invention in detail, the SD, Mini SD, and MMC memory cards are taken as examples. If the card reading interface 110 includes more memory cards 320 of different specifications, the method below can also be used to switch between various memory cards 320.

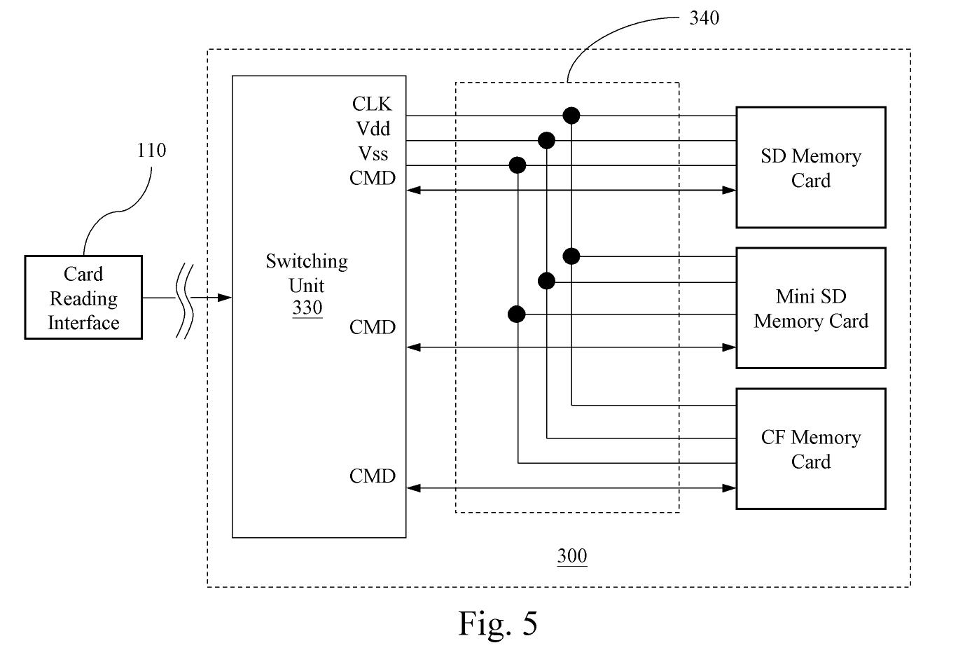

Referring to FIG. 5, a schematic view showing the connection of the memory cards of the present invention is shown. Assuming the SD card is a first memory card under test, and the chip selecting pin of the SD card operates normally at a low level, and sends a disabling instruction to the selected memory card 320 at a high level. When the testing device 300 is placed into the card reading interface 110, the testing device 300 will receive the switching instruction sent from the laptop computer, so as to trigger the chip selecting pin in the SD card (to enable the SD card by lowering the level), such that the SD card is selected as the memory card 320 to be detected. After the SD card is tested, the laptop computer sends another switching instruction, and increases the level of the chip selecting pin of the SD card, so as to disable the SD card. Then, the switching unit 330 in the testing device 300 detects the change, and switches the SD card to the SPI mode. At this time, the laptop computer and the SD card remain at the SPI communication mode. The laptop computer then selects the memory card 320 for the next testing, and repeats the steps of switching, testing, communicating, and selecting, until all of the memory cards 320 are tested.

The present invention provides a testing device 300 of a card reading interface 110, which is connected to a card reading interface slot having a plurality of specifications of memory card interfaces, so as to reduce the times that memory cards are inserted in or drawn out from the card reading interface slot. The laptop computer sends the switching instruction, so as to select the memory card interface under test.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A testing device of a card reading interface, applied to a card reading interface having a plurality of memory card interfaces, and integrating the memory card interfaces in a memory card slot of the card reading interface, wherein the card reading interface is electrically connected to a laptop computer, the testing device comprising:
a plurality of memory cards;
a switching unit, electrically connected to the laptop computer, wherein the switching unit receives a switching instruction sent from the laptop computer, and selects a corresponding memory card according to the received switching instruction;
a connecting part, electrically connected between the memory card slot and the switching unit; and
a connecting circuit, electrically connected between the switching unit and the memory cards, for transmitting a plurality of detection data, such that the laptop computer detects the detection data before and after the detection data are accessed, so as to determine whether the memory card slot functions are normally.

2. The testing device of a card reading interface as claimed in claim 1, wherein the memory card slot at least comprises a CF interface, an SD interface, an MS interface, an SM interface, an XD interface or an MMC interface, and an MS Pro interface.

3. The testing device of a testing device as claimed in claim 1, wherein the memory card is a CF memory card, a SD memory card, a MS memory card, a SM memory card, an XD memory card or a MMC memory card, and a MS Pro memory card.

4. The testing device of a testing device as claimed in claim 1, wherein the switching instruction is a Serial Peripheral Interface (SPI) command, which triggers a chip selecting pin in the memory card, such that the memory card is selected to be detected.

5. A testing method of a card reading interface, applied to a card reading interface having a plurality of memory card interfaces, and integrating the memory card interfaces in a memory card slot, the testing method comprising:
integrating a plurality of memory cards in a testing device;
electrically connecting the testing device with the memory card interfaces of the memory card slot;
selecting a memory card under test from the memory cards, and establishing communication between the selected memory card and the corresponding memory card interface in the memory card slot through the testing device; and
sending a detection data to the selected memory card, reading the sent detection data from the selected memory card, and comparing the sent detection data and the read data, so as to determine whether an error occurs in the corresponding memory card interface in the memory card slot.

6. The testing method of a card reading interface as claimed in claim 5, wherein the memory card slot at least comprises a CF interface, a SD interface, a MS interface, a SM interface, a XD interface or a MMC interface, and a MS Pro interface.

7. The testing method of a testing device as claimed in claim 5, wherein the memory card is a CF memory card, a SD memory card, a MS memory card, a SM memory card, a XD memory card or a MMC memory card, and a MS Pro memory card.

8. The testing method of a testing device as claimed in claim 5, wherein the switching method further comprises providing a Serial Peripheral Interface (SPI) command to trigger a chip selecting pin in the memory card, such that the memory card is selected to be detected.
